(19) United States
(12) Patent Application Publication
(10) Pub. No.: US 2017/0330306 A1
(43) Pub. Date: Nov. 16, 2017

(54) DISTORTED IMAGE CORRECTING APPARATUS AND METHOD

(71) Applicant: MStar Semiconductor, Inc., Hsinchu Hsien (TW)

(72) Inventors: Jen-Shi Wu, Hsinchu Hsien (TW); Chung-Yi Chen, Hsinchu Hsien (TW); Cheng-Liang Wang, Hsinchu Hsien (TW)

(21) Appl. No.: 15/405,655

(22) Filed: Jan. 13, 2017

(30) Foreign Application Priority Data
May 10, 2016 (TW) 105114351

(51) Int. Cl. G06T 5/00; G06F 3/06; G06T 1/60; G06F 12/06

(52) U.S. Cl. CPC G06T 5/002; G06F 12/06; G06F 3/0625; G06F 3/0631; G06F 3/064; G06T 5/006; G06T 1/60; G06F 3/0608; G06F 3/0673; G06F 3/0656; G06F 2212/7203; G06F 2212/1028; G06F 2212/1044; G06T 2207/10004

(57) ABSTRACT

A distorted image correcting apparatus corrects a distorted image to generate a corrected image. The distorted image correcting apparatus includes: a buffer, including a plurality of memory blocks each storing one of a plurality of blocks of data of the distorted image; an allocation circuit, allocating the memory blocks in the buffer according to a memory configuration, wherein the memory blocks have different memory capacities; a memory controller, retrieving the blocks of data of the distorted image from a memory and storing the blocks of data to the buffer according to the memory configuration; and a correction circuit, retrieving a block of data from a memory block of the buffer, and generating a part of the corrected image according to the block of data.

This application claims the benefit of Taiwan application Serial No. 105114351, filed May 10, 2016, the subject matter of which is incorporated herein by reference.

### BACKGROUND OF THE INVENTION

### Field of the Invention

The invention relates in general to image processing, and more particularly to a distorted image correcting apparatus and method.

### Description of the Related Art

When image is formed through an imaging lens, a formed image is distorted due to optical distortion to appear arc-shaped or ellipsoidal. Therefore, the distorted image needs to be corrected in order to obtain a corrected image.

FIG. 1 shows a schematic diagram of a capacity of a buffer needed for correcting a distorted curve of a distorted image in the prior art. In the prior art, to correct a distorted curve 108 of a distorted image 104, image data 106 enclosing the entire distorted curve 108 is loaded from a dynamic random access memory (DRAM) to a buffer (e.g., a static random access memory (SRAM)), and a correction process is performed subsequently to obtain a horizontal line 110 at the uppermost part of the corrected image 102.

### SUMMARY OF THE INVENTION

It is an object of the present invention to provide a distorted image correcting apparatus and method capable of reducing the usage amount of a buffer without affecting the correction capability, so as to increase the utilization efficiency of the buffer as well as reducing the usage amount of system resources and power consumption.

The present invention discloses a distorted image correcting apparatus adapted to a correct distorted image to generate a corrected image. The distorted image correcting apparatus include: a buffer, including a plurality of memory blocks each storing one of a plurality of blocks of data of the distorted image; an allocation circuit, allocating the memory blocks in the buffer according to a memory configuration, wherein the memory blocks have different memory capacities; a memory controller, retrieving the blocks of data of the distorted image from a memory and storing the blocks of data to the buffer according to the memory configuration; and a correction circuit, retrieving one block of data from a memory block of the buffer according to the memory configuration, and generating a part of the corrected image according to the block of data.

The present invention further discloses a distorted image correcting method for correcting a distorted image to generate a corrected image. The distorted image correcting method includes: allocating a plurality of memory blocks in a buffer according to a memory configuration, wherein the memory blocks have different memory capacities; retrieving a plurality of blocks of data of the distorted image from a memory; storing the blocks of data to the buffer according to the memory configuration, wherein the buffer includes a plurality of memory blocks corresponding to and respectively storing the plurality of blocks of data; and retrieving one block of data from a memory block of the buffer according to the memory configuration, and generating a part of the corrected image according to the block of data

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a capacity of a buffer needed for correcting a distorted curve of a distorted image in the prior art;

FIG. 2 is a function block diagram of a distorted image correcting apparatus according to an embodiment of the present invention;

FIG. 3 is a partial schematic diagram of a distortion map;

FIG. 4 is a schematic diagram of estimated data sizes of blocks of data required for generating sections of each of the corrected horizontal lines;

FIG. 5 is a schematic diagram of an example of blocks of data required for generating sections of a horizontal line by the present invention in a distorted image; and

FIG. 6 is a flowchart of a distorted image correcting method according to an embodiment of the present invention.

### DETAILED DESCRIPTION OF THE INVENTION

The present invention discloses a distorted image correcting apparatus and method. A part of the elements of the apparatus and system may be individually known elements. Without affecting full disclosure and possible implementation of the present invention, details of these individually known elements are omitted herein. Further, the method may be in form of software and/or firmware, and may be performed by an apparatus of the present invention or an equivalent device.

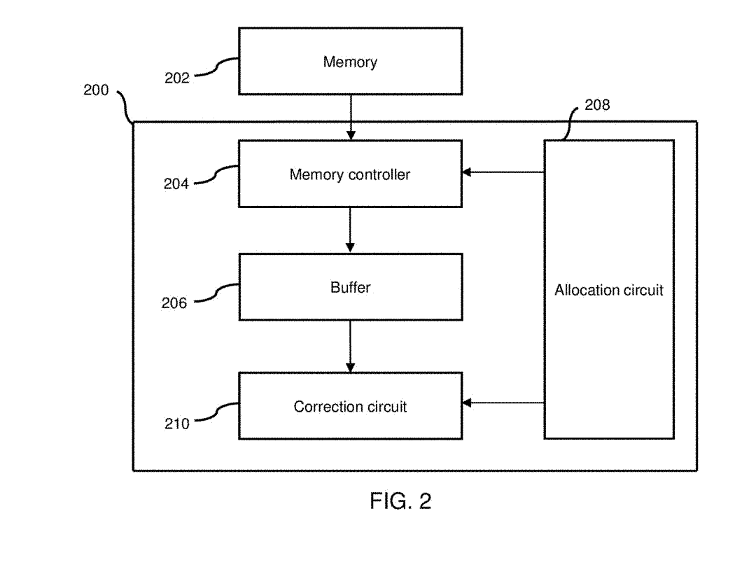

FIG. 2 shows a function block diagram of a distorted image correcting apparatus according to an embodiment of the present invention. As shown in FIG. 2, a distorted image correcting apparatus 200, adapted to correct a distorted image to generate a corrected image, includes a memory controller 204, a buffer 206, an allocation circuit 208 and a correction circuit 210. Coupling relationships among the above components may be learned from FIG. 2 and shall be omitted herein.

The buffer 206 may be, for example but not limited to, an SRAM, and includes a plurality of memory blocks, each storing one block of data of the distorted image. For example, assume that the resolution of an image is 1280×720, i.e., the frame includes 720 horizontal lines each including 1280 pixels, and each horizontal line is divided into 10 sections in the horizontal direction, i.e., each section includes 128 pixels. Thus, the buffer 206 correspondingly includes 10 memory blocks. Since the distortion level of each section in the distorted image differs from that of another and the block of data needed for correction gets larger as the distortion level gets more severe, the memory capacities of the memory blocks may be individually set according the respective distortion levels to more effectively utilize the memory. The distortion levels of the distorted image may be learned from a distortion map of the imaging lens. The distortion map records the position correspondence for a pixel between a corrected image and a distorted image. By referring to the distortion map, the data required for correcting each section can be obtained. Details for determining the memory sizes of memory blocks of the buffer 206 according to the distortion map are given below.

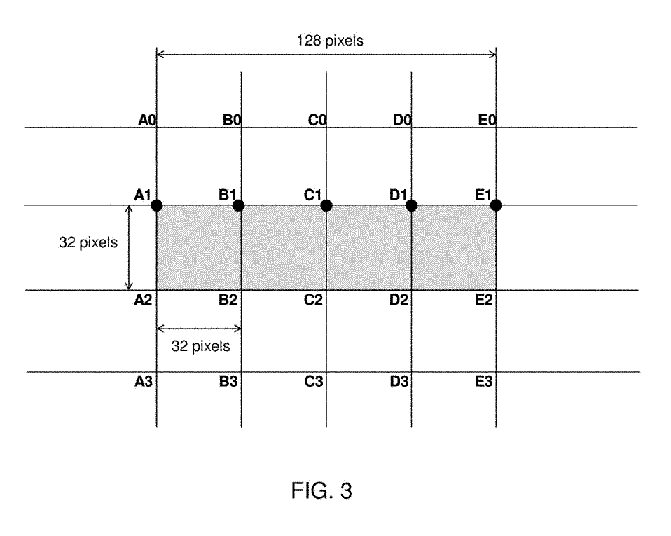

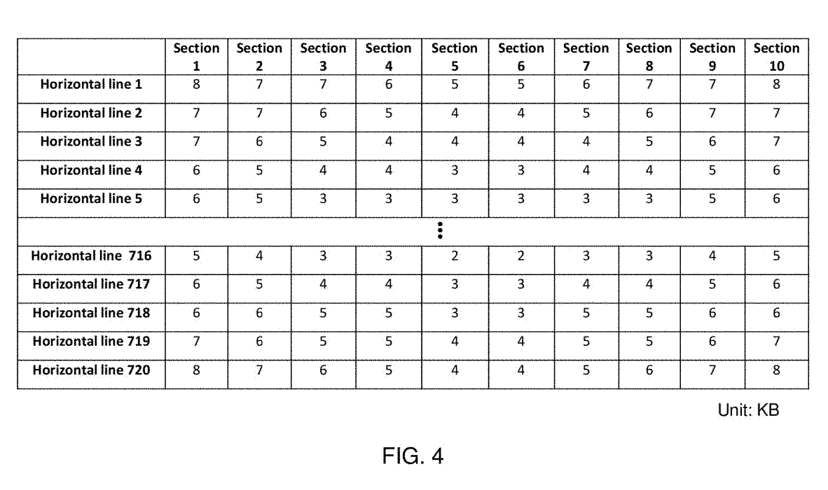

FIG. 3 shows a partial schematic diagram of a distortion map. The resolutions of the distortion map in the horizontal and vertical directions are both 32 pixels. That is, for pixels at intersections A0, A1, A2 . . . , B0, B1, B2 . . . , position correspondences are recorded in the distortion map, whereas for pixels that are not at these intersections, the position correspondences are obtained by interpolation. Assume that coordinates corresponding to the intersections A1, B1, C1, D1 and E1 of the 2^{nd} section of the 3^{rd} horizontal line of the corrected image are (128, 2), (160, 2), (192, 2), (224, 2) and (256, 2), respectively (it is defined that the y-coordinate of the 1^{st} horizontal line is 0), and the corresponding distorted pixel positions are (128, 80), (160, 78), (192, 75), (224, 70) and (256, 64), respectively. It should be noted that, distortion in the vertical direction is given as an example, and one person skilled in the art may apply the same concept to process distortion of other dimensions based on the description below. However, strictly speaking, the pixel range of the 2^{nd} section is from 128 to 255. Assuming that the distorted pixel position corresponding to the coordinates (255, 2) obtained from interpolation is (255, 65), the data distribution range of the original pixels of the 2^{nd} section in the vertical direction in the distorted image is 65 to 80. Assuming that each of R, G, B of each pixel is represented by 8 bits, the total data amount of each pixel is 24 bits, and so the estimated data size of the block required for correcting the 2^{nd} section is at least: 128×(80−65+1)×24/1024/8=6 KB. By repeating the above method, the estimated data size of block required for correcting each section of each horizontal line in FIG. 4 can be obtained, as shown in FIG. 4.

In one embodiment, the sizes of the 10 memory blocks of the buffer 206 may be determined according to a maximum estimated data size required for the section. For example, the memory capacity of the memory block 1 (corresponding to the section 1) of the buffer 206 is determined according to the maximum estimated data size of the block required for generating the section 1 of each corrected horizontal line. More specifically, the maximum value among the estimated data sizes of the block required for generating the section 1 of the corrected horizontal line 1 to the corrected horizontal line 720 is 8 KB; the memory capacity of the memory block 1 is determined to be 8 KB. Accordingly, the memory capacities of the memory blocks 1 to 10 corresponding to the sections 1 to 10 are determined to be 8 KB, 7 KB, 7 KB, 6 KB, 5 KB, 5 KB, 6 KB, 7 KB, 7 KB and 8 KB, respectively. These determined memory capacities are referred to a memory configuration.

Further, known from the memory configuration, the memory capacity of a memory block corresponding to a border block of data is greater than the memory capacity of a memory block corresponding to a central block of data. For example, the memory capacity 8 KB of the memory block 1 corresponding to the section 1 is greater than the memory capacity 7 KB of the memory block 2 corresponding to the section 2. For another example, the memory capacity 7 KB of the memory block 2 corresponding to the section 2 is greater than the memory capacity 6 KB of the memory block 4 corresponding to the section 4.

Further, the horizontal line 1 or the horizontal line 720 is in general the horizontal line with largest distortion level. Thus, in other embodiments, the memory configuration may be determined according to such characteristic. More specifically, either one of the two horizontal lines may be used (one of the two may be determined with reference to the distortion map when necessary) to calculate the estimated data size required by each of the sections. The sizes of the 10 memory blocks of the buffer 206 are allocated according to 10 estimated data sizes of the horizontal line 1 or the horizontal line 720. In one embodiment, the sizes of the memory blocks of the buffer 206 are, for example but not limited to, the same as the estimated data sizes. In another embodiment, the sizes of the memory blocks of the buffer 206 may be slightly larger than the estimated data sizes.

The allocation circuit 208 allocates the memory blocks in the buffer 206 according to the above memory configuration, wherein the memory blocks have different memory capacities. More specifically, the above memory configuration is represented by means of a starting address of the memory and an ending address of the memory in the allocation circuit 208. Thus, corresponding to the 10 memory blocks, the method of recording the memory configuration is, for example, (starting address 1, ending address 1), (starting address 2, ending address 2), . . . , (starting address 10, ending address 10). That is to say, the operation of the allocation circuit 208 allocating these memory blocks in the buffer 206 is in fact sending the above memory configuration to the memory controller 204, which is then allowed to access the buffer 206 according to the memory configuration.

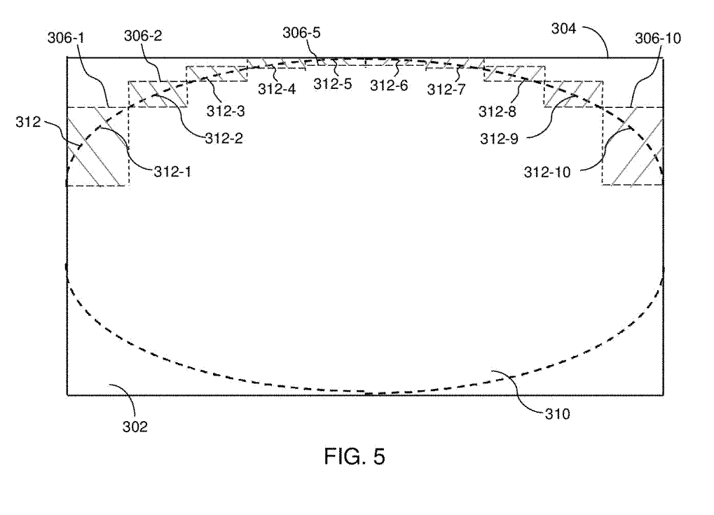

The memory controller 204 retrieves a plurality of blocks of data of the distorted image from the memory 202, and stores the blocks of data to the buffer 206. The memory 202 may be, for example but not limited to, a DRAM. As shown in FIG. 2, the memory 202 may be disposed outside the correcting apparatus 200. In another embodiment, the memory 202 may be disposed in the correcting apparatus 200. FIG. 5 shows a schematic diagram of an example of a distorted image and corresponding blocks of data for the distorted image correcting apparatus of the present invention. In this example, a distorted curved 312 of a distorted image 310 is divided into 10 sections (the range included in the dotted lines), for example but not limited to, distorted segments 312-1 to 312-10. The distorted curve 312 may be divided into N sets of distorted data, where N is a positive integer greater than 1. As shown by the example in FIG. 5, the memory controller 204 sequentially duplicates or relocates the block of data 306-1 including the distorted segment 312-1, the block of data 306-2 including the distorted curved 312-2 . . . , and the block of data 306-10 including the distorted segment 312-10 from the memory 202 to the buffer 206. When writing these blocks of data to the buffer 206, the memory controller 204 writes these blocks of data to the corresponding memory addresses with reference to the memory configuration. As shown in FIG. 5, because the distortion level of the distorted curve 312 close to the border of the image is more severe than the distortion level at the center of the image (e.g., the distorted segments 312-1 and 312-10 are more curved than the distorted segments 312-5 and 312-6), the amount of a block of data required for correcting the segment close to the border of the image is larger than the amount of a block of data required for correcting the segment close to the center of the image (e.g., the amounts of the blocks of data 306-1 and 306-10 are larger than the amount of the block of data 306-5).

The correction circuit 210 retrieves a block of data from a memory block of the buffer 206 according to the memory configuration, and generates a part of the corrected image according to the block of data. In continuation of the above example, when the memory controller 204 writes the 10 blocks of data required for correcting one horizontal line to the 10 corresponding memory blocks in the buffer 206, the correction circuit 210 reads these blocks of data from the buffer 206 according to the memory addresses recorded in the memory configuration, and performs the correction process according to the distortion map. More specifically, the correction circuit 210 re-orders the pixels in the distorted image according to the distortion map to restore these pixels to corresponding positions in the corrected image. Similarly, during the process of re-ordering the pixels, interpolation may be performed when necessary. After the correction circuit 210 respectively corrects the 10 sections shown in FIG. 5, the distorted curve 312 may be ideally corrected to the horizontal line 304.

In one embodiment, the memory controller 204, the buffer 206, the allocation circuit 208 and the correction circuit 210 are located within the same integrated circuit, whereas the memory 202 is outside the integrated circuit. In another embodiment, the memory 202, the memory controller 204, the buffer 206, the allocation circuit 208 and the correction circuit 210 may be located in the same integrated circuit. The allocation circuit 208 may be implemented by one or multiple processors in conjunction with software, and the memory configuration may be stored in a flash memory.

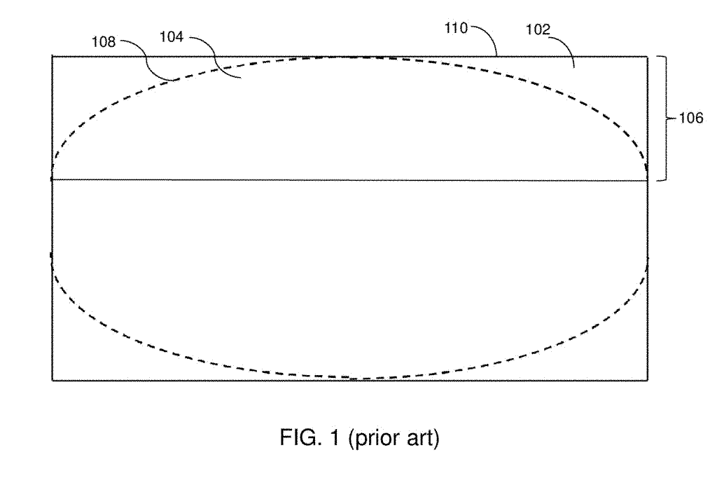

Compared to FIG. 1, the sizes of the 10 blocks data required for correcting the 10 distorted segments of the distorted curve 312 corrected by the correcting method in FIG. 3 in total is smaller than the size of the image data 106 required for correcting the distorted curve 108 in the prior art. In other words, without affecting the correction capability, the distorted image correcting apparatus 200 of the present invention reduces the buffer usage, hence enhancing the utilization efficiency of the buffer as well as reducing the usage amount of system resources and power consumption.

In the above embodiments, the memory configuration is stored in the flash memory in advance. It should be noted that, the distortion map may differ for optical lenses having different specifications. For example, in a system including front and rear lenses or replaceable lenses, a plurality of memory configurations corresponding to optical lenses having different specification may be stored in advance, so as to achieve effects of reducing system resources and power consumption. In another embodiment, the memory configuration may also be dynamically generated by the allocation circuit according to the distortion map of an optical lens.

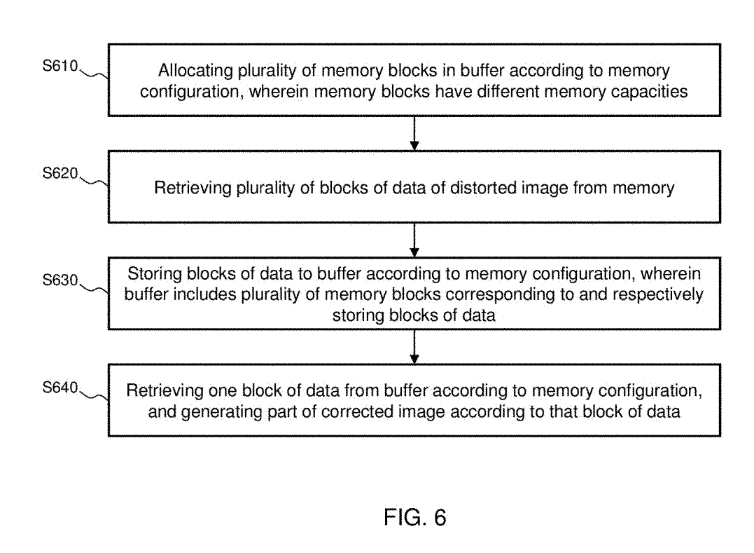

FIG. 6 shows a flowchart of a distorted image correcting method according to an embodiment of the present invention. The distorted image correcting method is used to perform correction on a plurality of blocks of data of a distorted image retrieved from an external memory to obtain a corrected image. Referring to FIG. 6, the distorted image correcting method includes following steps.

In step S610, a plurality of memory blocks are allocated in a buffer according to a memory configuration, wherein the memory blocks have different memory capacities. More specifically, according to sizes of sections, a distortion map and a bit count of each pixel, the estimated data sizes shown in FIG. 4 may be obtained, and the memory configuration may be determined according to the estimated data sizes. According to the memory configuration, the buffer may be configured into a plurality of memory blocks having different memory capacities.

In step S620, a plurality of blocks of data of the distorted image is retrieved from a memory. The non-corrected distorted image is buffered in the memory. To perform correction, according to a section and the distortion map, a corresponding block of data required by the section is retrieved from the memory. The amount of each block of data is smaller than or equal to the memory capacity of the corresponding memory block. Further, because distortion levels of the blocks are different, the sizes of different blocks of data required for correcting the individual blocks are also different.

In step S630, according to the memory configuration, the block of data read in step S620 is stored to the buffer. The buffer includes a plurality of memory blocks corresponding to and respectively storing the blocks of data. In one embodiment, the memory configuration records a starting address and an ending address of each of the memory blocks. Thus, this step stores the blocks of data to appropriate positions in the buffer according to the starting addresses and the ending addresses.

In step S640, a block of data is retrieved from a memory block of the buffer, and a part of the corrected image is generated according to the block of data. After the block of data is obtained from the buffer, pixels in the block of data are re-ordered according to the distortion map to correct a part of the distorted image, so as to obtain a part of the corrected image corresponding the block of data. Because the distortion map contains resolution limitations, interpolation is performed on the distortion map during the process of re-ordering the pixels when necessary.

One person skilled in the art may deduce details and variations of the method of the embodiment according to the disclosure of the foregoing apparatus and method. More specifically, the technical characteristics of the foregoing apparatus and method may be reasonably applied to the method of this embodiment. Without affecting full disclosure and possible implementation of the method of the embodiment, such repeated details are omitted herein.

In conclusion, in the present invention, a buffer memory is divided into a plurality of memory blocks for individually and correspondingly storing required blocks of data for a distorted image, and memory capacities of individual memory blocks are configured according to a distortion map. Thus, the present invention is capable of reducing a capacity of the buffer to reduce costs, system resources and power consumption.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A distorted image correcting apparatus, correcting a distorted image to generate a corrected image, comprising:
a buffer, comprising a plurality of memory blocks, each storing one of a plurality of blocks of data of the distorted image;
an allocation circuit, allocating the memory blocks according to a memory configuration, wherein the memory blocks have different memory capacities;
a memory controller, retrieving the blocks of data of the distorted image from a memory, and storing the blocks of data to the buffer according to the memory configuration; and
a correction circuit, retrieving a block of data from a memory block of the buffer according to the memory configuration, and generating a part of the corrected image according to the block of data.

2. The distorted image correcting apparatus according to claim 1, wherein the blocks of data comprises a border block of data and a central block of data, the central block of data is closer to a center of the distorted image than the border block of data, and the memory capacity of a memory block corresponding to the border block of data is larger than the memory capacity of a memory block corresponding to the central block of data.

3. The distorted image correcting apparatus according to claim 1, wherein the memory configuration comprises a starting address and an ending address of a memory block in the buffer, and the starting address and the ending address of the memory block are generated according to an estimated data size of a corresponding block of data of the memory block.

4. The distorted image correcting apparatus according to claim 3, wherein the memory capacity of the memory block corresponding to the starting address and the ending address is equal to the estimated data size of the data of the corresponding block of data of the memory block.

5. The distorted image correcting apparatus according to claim 3, wherein the starting address and the ending address of the memory block are generated according to a plurality of estimated data sizes of a plurality of corresponding blocks of data of the memory block.

6. The distorted image correcting apparatus according to claim 5, wherein the memory capacity of the memory block corresponding to the starting address and the ending address is equal to a maximum value of the estimated data sizes of the corresponding blocks of the memory block.

7. The distorted image correcting apparatus according to claim 3, wherein the estimated data size of the corresponding block of data is calculated according to a distortion map of the corresponding block of data, and the distortion map comprises position correspondence between the distorted image and the corrected image.

8. A distorted image correcting method, for correcting a distorted image to generate a corrected image, comprising:
allocating a plurality of memory blocks in a buffer according to a memory configuration, wherein the memory blocks have different memory capacities;
retrieving a plurality blocks of data of the distorted image from a memory;
storing the blocks of data to the buffer according to the memory configuration, wherein the buffer comprises a plurality of memory blocks corresponding to the blocks of data and each storing one of the blocks of data; and
retrieving a block of data from a memory block of the buffer according to the memory configuration, and generating a part of the corrected image according to the block of data.

9. The distorted image correcting method according to claim 8, wherein the blocks of data comprises a border block of data and a central block of data, the central block of data is closer to a center of the distorted image than the border block of data, and the memory capacity of a memory block corresponding to the border block of data is larger than the memory capacity of a memory block corresponding to the central block of data.

10. The distorted image correcting method according to claim 8, wherein the memory configuration comprises a starting address and an ending address of a memory block in the buffer, and the starting address and the ending address of the memory block are generated according to an estimated data size of a corresponding block of data of the memory block.

11. The distorted image correcting method according to claim 10, wherein the memory capacity of the memory block corresponding to the starting address and the ending address is equal to the estimated data size of the data of the corresponding block of data of the memory block.

12. The distorted image correcting method according to claim 10, wherein the starting address and the ending address of the memory block are generated according to a plurality of estimated data sizes of a plurality of corresponding blocks of data of the memory block.

13. The distorted image correcting method according to claim 12, wherein the memory capacity of the memory block corresponding to the starting address and the ending address is equal to a maximum value of the estimated data sizes of the corresponding blocks of the memory block.

14. The distorted image correcting method according to claim 10, wherein the estimated data size of the corresponding block of data is calculated according to a distortion map of the corresponding block of data, and the distortion map comprises position correspondence between the distorted image and the corrected image.
